(19) United States
(12) Patent Application Publication
(10) Pub. No.: US 2003/0065496 A1
(43) Pub. Date: Apr. 3, 2003

(54) Effective value impedance simulation method and apparatus and effective value impedance simulation program

(75) Inventors: Yasushi Fujimoto, Chiba (JP); Katsuhisa Tokuhara, Tokyo (JP); Hitoshi Mitsuma, Kanagawa (JP); Nobuyuki Sato, Kanagawa (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/187,303

(22) Filed: Jul. 2, 2002

(30) Foreign Application Priority Data
Jul. 6, 2001 (JP) 2001-206388

(51) Int. Cl. G06F 17/50

(52) U.S. Cl. 703/15

(57) ABSTRACT

It is intended to provide an effective value impedance simulation method and apparatus in which even when an external circuit is opened or short-circuited, no infinite current or voltage occurs, no instability occurs in a numerical analysis, and the probability that a physical apparatus is broken is low. An instantaneous value/effective value conversion section connects a resistor and an externally controllable current source in parallel, measures an instantaneous value current i that flows through the parallel connection of the resistor and the current source, and converts the measured instantaneous value current i into an effective value current I. Another instantaneous value/effective value conversion section measures an instantaneous value voltage v that is applied to the parallel connection of the resistor and the current source, and converts the measured instantaneous value voltage v into an effective value voltage V. A calculation processing section calculates an effective value current H that should flow through the current source by using at least one of the effective value current I and the effective value voltage V. An effective value/instantaneous value conversion section converts the calculated effective value current H into an instantaneous value current h and causing the instantaneous value current h to flow through the current source.

### BACKGROUND OF THE INVENTION

1. Field of the Invention

The present invention relates to an effective value impedance simulation method and apparatus for simulating an electric device whose characteristic is given as an effective value impedance, as well as to an effective value impedance simulation program for causing a computer to simulate such an electric device.

2. Description of the Prior Art

Methods for analyzing a transient phenomenon of an electric circuit are known in which currents and voltages in the electric circuits are expressed as effective values (Reference 1: H. W. Dommel and N. Sato, “Fast Transient Stability Solutions,” IEEE Trans. Power Apparatus Syst. PAS-91, p. 1643 (1972)). In these methods, calculations are performed with an assumption that currents and voltages in an electric circuit are AC currents and voltages having a certain frequency (rated frequency). Because of use of a computer, this type of analysis is called “digital simulation.” In particular, it is called “effective value digital simulation” because currents and voltages are expressed as effective values. Where a computer for performing such an analysis is included, a term “effective value digital simulator” is used.

Where currents and voltages in an electric circuit cannot be expressed as those having a constant frequency, the following two methods are used instead of effective value digital simulation.

The first method is numerical electric circuit analysis (simulation) in which currents and voltages are expressed as instantaneous values. An example of the electric circuit analysis using instantaneous values is EMTP (Reference 2: “Personal Computer Simulation of Power Systems,” edited by Akihiro Ametani, Supplement to OHM September issue, September 1998, Ohm-Sha, Ltd.). This type of analysis makes it possible to analyze circuit network transient phenomena in a wider range than the effective value digital simulation because currents and voltages in an electric circuit need not be steady AC currents and voltages. This type of analysis is called “instantaneous value digital simulation.” Where an apparatus for performing an analysis is included, a term “instantaneous value digital simulator” is used.

The second method is such that a miniature equivalent circuit network having the same characteristics as an analysis subject electric circuit is constructed physically and a transient phenomenon is analyzed by using it. This is called “analog simulator” as opposed to the digital simulator.

In the above circumstances, it is desired to analyze, in combination with an instantaneous value simulation, a transient phenomenon of an electric device whose characteristic is expressed as an effective value impedance, or to analyze a transient phenomenon of an electric circuit network that is a combination of an electric device whose characteristic is expressed as an effective value impedance and a physically constructed circuit network (analog simulator).

Conventionally, to satisfy the above desires, an electric device having the same effective value impedance as a target effective value impedance is constructed as a combination of simple passive elements or the magnitude of the output voltage or current of an externally controllable voltage source or current source is adjusted.

For example, consideration will be given to a case of expressing an electric device having an effective value impedance of 10+10j Ω at a frequency 50 Hz in an instantaneous value simulation or implementing it in the form of a physical circuit to be connected to an analog simulator.

One conventional method is to use, as an equivalent circuit, an electric circuit shown in FIG. 7 that is a series connection of a resistor 601 and an inductance (coil) 602. In a digital simulator, an ordinary modeling method (see Reference 2, for example) is applied to the LR device of FIG. 7.

However, this method mainly has the following two problems.

The first problem resides in a transient phenomenon characteristic of this circuit. Assume a circuit shown in FIG. 8 that includes the circuit of FIG. 7. In FIG. 8, reference numeral 701 denotes an effective value impedance simulation circuit; 702, a switch, 703, an external voltage source; 704 and 705, the ground; and 706, a connection point (node).

When the switch 702 is opened, a very high voltage occurs at the node 706. Such a characteristic is not preferable for the circuit whose characteristic is given as only the complex impedance at 50 Hz. If this equivalent circuit is used for a numerical simulation on a computer, it may cause numerical instability. Where the circuit of FIG. 8 is implemented physically, there is a possibility of circuit breakdown due to a high voltage.

The other problem is that it is difficult to realize a time-variant effective value impedance, though such is often desired. For example, consideration will be given to a case of simulating a circuit whose effective value impedance is 10+10j Ω when time t<0 and is 10−10j Ω when time t≧0. Assume that the circuit of FIG. 7 is used for t<0 and a circuit of FIG. 9 is used for t≧0. In FIG. 9, reference numeral 801 denotes a resistor and reference numeral 802 denotes a capacitor.

Where the above effective value impedance is simulated by an instantaneous value numerical simulation by using a computer, how to set initial charge of the capacitor 802 at t=0 is a problem.

Where the target circuit should be implemented physically, it is necessary to prepare a coil and a capacitor as two physical elements; for example, it is necessary to prepare a circuit shown in FIG. 10.

In FIG. 10, reference numeral 901 denotes a resistor; 902, an inductance (coil); 903, a capacitor; and 904, a changeover switch. Also in the case of the circuit of FIG. 10, the capacitor 903 needs to be charged in advance and how to set initial charge of the capacitor 903 in what amount is a problem. Where more effective value impedances that vary with time are involved, it is difficult for the above method to implement a target circuit physically.

There is another conventional method in which an effective impedance is expressed as a voltage source or a current source.

For example, consideration will be given to a case of simulating a target effective value impedance Z by controlling the magnitude of the output voltage of a voltage source shown in FIG. 11. In FIG. 11, reference numeral 1001 denotes a voltage source and reference numeral 1002 denotes a voltage source indication value calculation section.

This is similar to a simulator that is obtained by omitting harmonic portions of a “power system harmonics real-time simulator” that is described in Japanese Unexamined Patent Publication No. 11-252976 and interchanging a current and a voltage. In the method of the publication No. 11-252976, a current phase is merely determined with a measured voltage used as a reference. However, a circuit having the desired effective value impedance characteristic can be constructed by calculating an effective value voltage based on an effective value of a measured current and the given effective value impedance, converting it into an instantaneous value, and driving the voltage source using the obtained instantaneous value.

Specifically, a current i flowing through the circuit is converted into an effective value I. An effective value voltage E is calculated according to E=IZ. Where the effective value voltage E is given by

E=E0exp(jθ)

where E0 is an effective value amplitude and θ is a phase, a circuit having the target effective value impedance can be obtained by controlling the voltage source (voltage amplifier) in such a manner that its output voltage e becomes

e=SQRT(2.)E0cos(ωt+θ).

Similarly, it is possible to simulate the target effective value impedance Z by controlling the magnitude of the output current of a current source shown in FIG. 12. In FIG. 12, reference numeral 1101 denotes a current source and reference numeral 1102 denotes a current source indication value calculation section.

Specifically, a voltage v across the circuit is converted into an effective value V. An effective value current H is calculated according to H=V/Z. Where the effective value current H is given by

H=H0exp(jθ)

where H0 is an effective value amplitude and θ is a phase, a circuit having the target effective value impedance can be obtained by controlling the current source in such a manner that its output current i becomes

h=Sqrt(2.)H0cos(ωt+θ).

However, the methods using the voltage source of FIG. 11 or the current source of FIG. 12 may cause instability depending on the external circuit used.

For example, in the method using the voltage source of FIG. 11, if a circuit consisting of an effective value impedance simulation circuit 1201, a switch 1202, an external voltage source 1203, the ground 1204 and 1205, and a connection point (node) 1206 is given as shown in FIG. 13, theoretically an infinite current flows when the switch 1202 is closed. This means that numerical value instability occurs when this method is used in an instantaneous value digital simulation, and that an overcurrent may break an apparatus when a circuit is constructed physically.

Similarly, in the method using the current source of FIG. 12, if a circuit consisting of an effective value impedance simulation circuit 1301, a switch 1302, an external current source 1303, the ground 1304 and 1305, and a connection point (node) 1306 is given as shown in FIG. 14, theoretically an infinite voltage occurs at the node 1306 when the switch 1302 is opened. This means that numerical value instability occurs when this method is used in an instantaneous value numerical simulation, and that an overvoltage may break an apparatus when a circuit is constructed physically.

### BRIEF SUMMARY OF THE INVENTION

The present invention has been made to solve the above problems in the art, and an object of the invention is therefore to provide an effective value impedance simulation method and apparatus and an effective value impedance simulation program for causing a computer to simulate an effective value impedance in which even when an external circuit is opened or short-circuited, no infinite current or voltage occurs, no instability occurs in a numerical analysis, and the probability that a physical apparatus is broken is low.

Another object of the invention is to provide an effective value impedance simulation method and apparatus and an effective value impedance simulation program for causing a computer to simulate an effective value impedance in which even in the case where an effective value impedance to be simulated varies with time, the only modification needed is to change a calculation formula in a calculation processing section and it is not necessary to prepare a number of physical circuits or initialize an element for connection switching.

A further object of the invention is to provide an effective value impedance simulation method and apparatus and an effective value impedance simulation program for causing a computer to simulate an effective value impedance which enable circuit simulations in a wide frequency range by adding a circuit for simulation of impedances at frequencies other than a fundamental frequency component.

An effective value impedance simulation method according to a first aspect of the invention comprises the steps of connecting a resistor and an externally controllable current source in parallel and measuring a current that flows through the parallel connection of the resistor and the current source; converting the measured current into an effective value current; measuring a voltage that is applied to the parallel connection of the resistor and the current source; converting the measured voltage into an effective value voltage; calculating an effective value current that should flow through the current source by using at least one of the effective value current and the effective value voltage; and converting the calculated effective value current into an instantaneous value current and causing the instantaneous value current to flow through the current source.

An effective value impedance simulation method according to a second aspect of the invention comprises the steps of connecting a resistor and an externally controllable voltage source in series and measuring a current that flows through the series connection of the resistor and the voltage source; converting the measured current into an effective value current; measuring a voltage that is applied to the series connection of the resistor and the voltage source; converting the measured voltage into an effective value voltage; calculating an effective value voltage that should be generated by the voltage source by using at least one of the effective value current and the effective value voltage; and converting the calculated effective value voltage into an instantaneous value voltage and causing the voltage source to generate the instantaneous value voltage.

An effective value impedance simulation method according to a third aspect of the invention comprises the steps of expressing an electric device as a parallel connection of a resistor and a current source at a time point concerned, and calculating an effective value current and an effective value voltage at the time point concerned based on a current and currents that flows and flew through the parallel connection at the time point concerned and preceding time points and a voltage and voltages that develops and developed across the parallel connection at the time point concerned and the previous time points; calculating an effective value current that will flow through the current source at the next time point based on at least one of the effective value current and the effective value voltage; and converting the calculated effective value current into an instantaneous value current and employing the instantaneous value current as an output current of the current source at the next time point.

An effective value impedance simulation method according to a fourth aspect of the invention comprises the steps of expressing an electric device as a series connection of a resistor and a voltage source at a time point concerned, and calculating an effective value current and an effective value voltage at the time point concerned based on a current and currents that flows and flew through the series connection at the time point concerned and preceding time points and a voltage and voltages that develops and developed across the series connection at the time point concerned and the previous time points; calculating an effective value voltage that will develop across the voltage source at the next time point based on at least one of the effective value current and the effective value voltage; and converting the calculated effective value voltage into an instantaneous value voltage and employing the instantaneous value voltage as an output voltage of the voltage source at the next time point.

Each of the effective value impedance simulation methods according to the fifth aspect of the invention may further comprise the step of simulating an effective value impedance at a frequency component other than an effective value impedance at a fundamental frequency component as a subject of analysis of the above steps.

An effective value impedance simulation apparatus according to a sixth aspect of the invention comprises first instantaneous value/effective value converting means for connecting a resistor and an externally controllable current source in parallel, measuring an instantaneous value current that flows through the parallel connection of the resistor and the current source, and converting the measured instantaneous value current into an effective value current; second instantaneous value/effective value converting means for measuring an instantaneous value voltage that is applied to the parallel connection of the resistor and the current source, and converting the measured instantaneous value voltage into an effective value voltage; first calculation processing means for calculating an effective value current that should flow through the current source by using at least one of the effective value current and the effective value voltage; and first effective value/instantaneous value converting means for converting the calculated effective value current into an instantaneous value current and causing the instantaneous value current to flow through the current source.

An effective value impedance simulation apparatus according to a seventh aspect of the invention comprises third instantaneous value/effective value converting means for connecting a resistor and an externally controllable voltage source in series, measuring an instantaneous value current that flows through the series connection of the resistor and the voltage source, and converting the measured instantaneous value current into an effective value current; fourth instantaneous value/effective value converting means for measuring an instantaneous value voltage that is applied to the series connection of the resistor and the voltage source, and converting the measured instantaneous value voltage into an effective value voltage; second calculation processing means for calculating an effective value voltage that should be generated by the voltage source by using at least one of the effective value current and the effective value voltage; and second effective value/instantaneous value converting means for converting the calculated effective value voltage into an instantaneous value voltage and causing the voltage source to generate the instantaneous value voltage.

Each of the effective value impedance simulation apparatuses according to the eighth aspect of the invention may further comprise a circuit for simulating an effective value impedance at a frequency component other than an effective value impedance at a fundamental frequency component as a subject of analysis of the above means.

An effective value impedance simulation program according to a ninth aspect of the invention causes a computer to execute a first converting step of expressing an electric device as a parallel connection of a resistor and a current source at a time point concerned, and calculating an effective value current and an effective value voltage at the time point concerned based on a current and currents that flows and flew through the parallel connection at the time point concerned and preceding time points and a voltage and voltages that develops and developed across the parallel connection at the time point concerned and the previous time points; a first calculating step of calculating an effective value current that will flow through the current source at the next time point based on at least one of the effective value current and the effective value voltage; and a second converting step of converting the calculated effective value current into an instantaneous value current and employing the instantaneous value current as an output current of the current source at the next time point.

An effective value impedance simulation program according to a tenth aspect of the invention causes a computer to execute a third converting step of expressing an electric device as a series connection of a resistor and a voltage source at a time point concerned, and calculating an effective value current and an effective value voltage at the time point concerned based on a current and currents that flows and flew through the series connection at the time point concerned and preceding time points and a voltage and voltages that develops and developed across the series connection at the time point concerned and the previous time points; a second calculating step of calculating an effective value voltage that will develop across the voltage source at the next time point based on at least one of the effective value current and the effective value voltage; and a fourth converting step of converting the calculated effective value voltage into an instantaneous value voltage and employing the instantaneous value voltage as an output voltage of the voltage source at the next time point.

### BRIEF DESCRIPTION OF THE DRAWINGS

FIG. 1 is an equivalent circuit diagram and a functional block diagram showing a first embodiment of the present invention;

FIG. 2 is an equivalent circuit diagram and a functional block diagram showing a second embodiment of the invention;

FIG. 3 is an equivalent circuit diagram and a flowchart showing a third embodiment of the invention;

FIG. 4 is an equivalent circuit diagram and a flowchart showing a fourth embodiment of the invention;

FIG. 5 shows the configuration of a circuit according to a fifth embodiment of the invention;

FIG. 6 is a flowchart showing the entire process of an instantaneous value digital simulation;

FIG. 7 shows an example equivalent circuit that is used in a first conventional method;

FIG. 8 shows a circuit for description of a problem of the first conventional method;

FIG. 9 shows another example equivalent circuit that is used in the first conventional method;

FIG. 10 shows a further example equivalent circuit that is used in the first conventional method;

FIG. 11 shows an example equivalent circuit that is used in a second conventional method;

FIG. 12 shows another example equivalent circuit that is used in the second conventional method;

FIG. 13 shows a circuit for description of a problem of the second conventional method; and

FIG. 14 shows another circuit for description of a problem of the second conventional method.

### DETAILED DESCRIPTION OF THE PREFERRED EMBODIMENTS

First, the basic concepts of the present invention will be described.

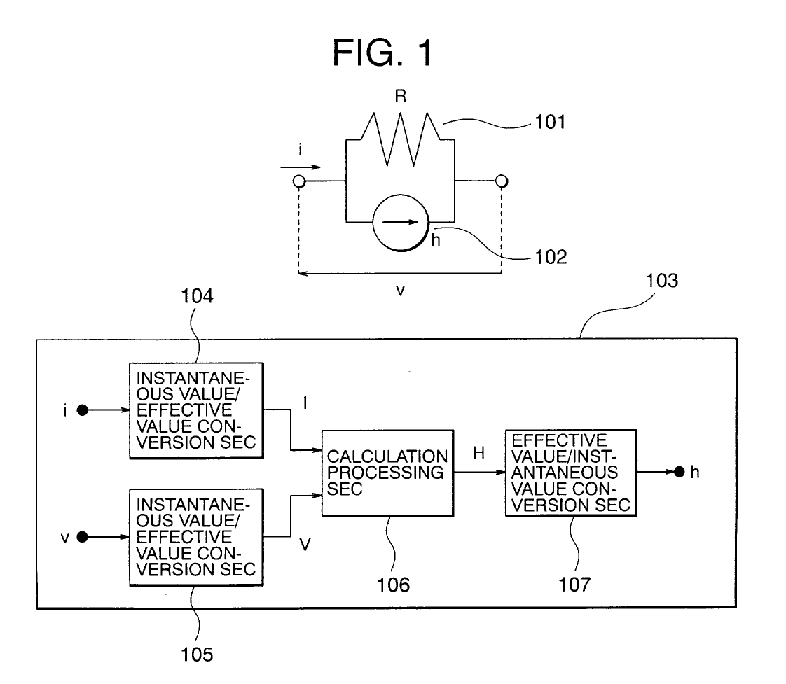

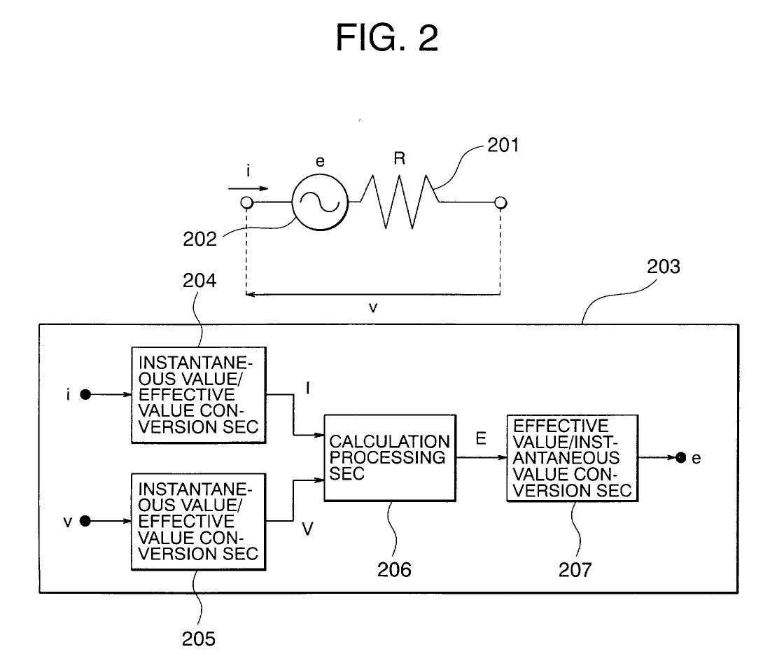

In the invention, an electric device whose characteristic is expressed as an effective value is expressed as a parallel connection of a resistor and a current source (see FIG. 1) or a series connection of a resistor and a voltage source (see FIG. 2). An output current h of the current source of FIG. 1 is given by calculating an effective value output current H of the current source based on effective values V and I obtained by converting a voltage v across the device and a current i flowing through it into effective values, and then converting the effective value output current H into the instantaneous value h. An output voltage e of the voltage source of FIG. 2 is given by calculating an effective value output voltage E of the voltage source based on effective values V and I obtained by converting a voltage v across the device and a current i flowing through it into effective values, and then converting the effective value output voltage E into the instantaneous value e.

First and second embodiments described later are physical circuit implementations of the above concepts.

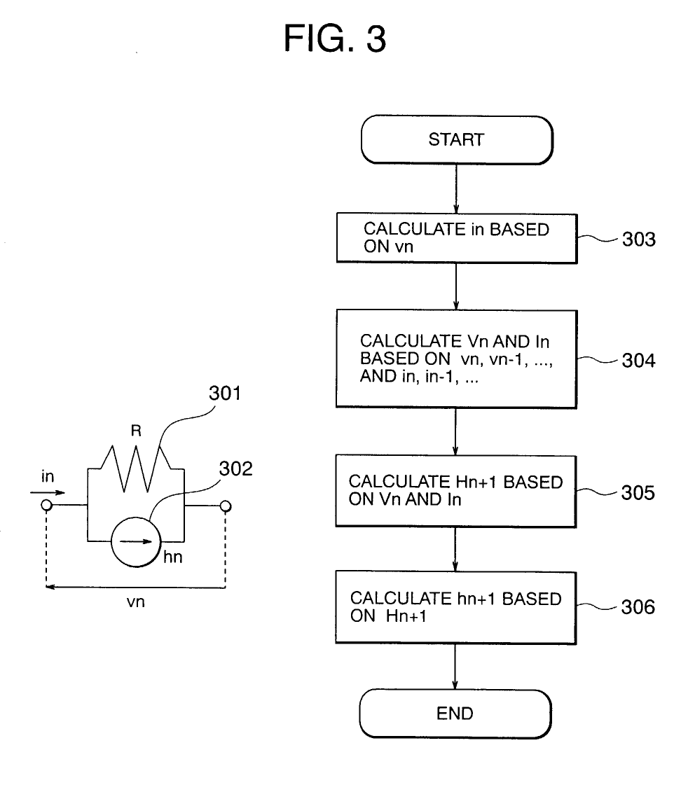

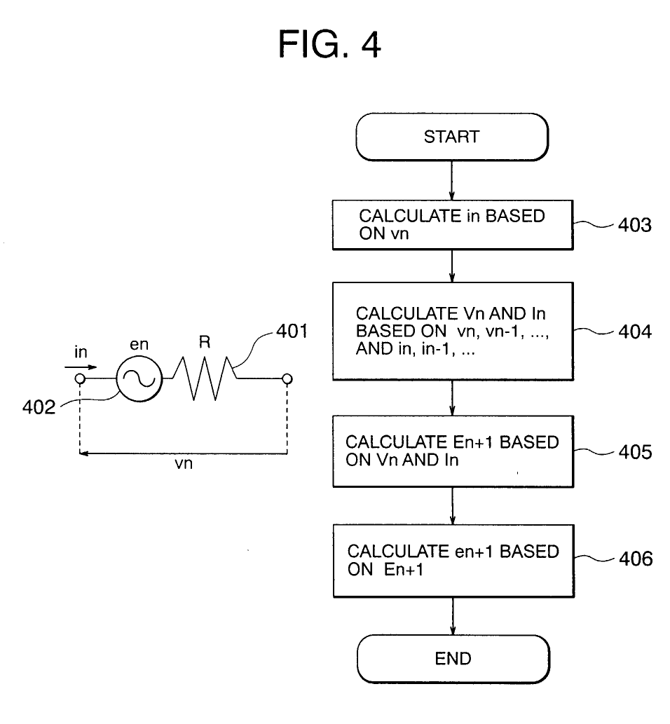

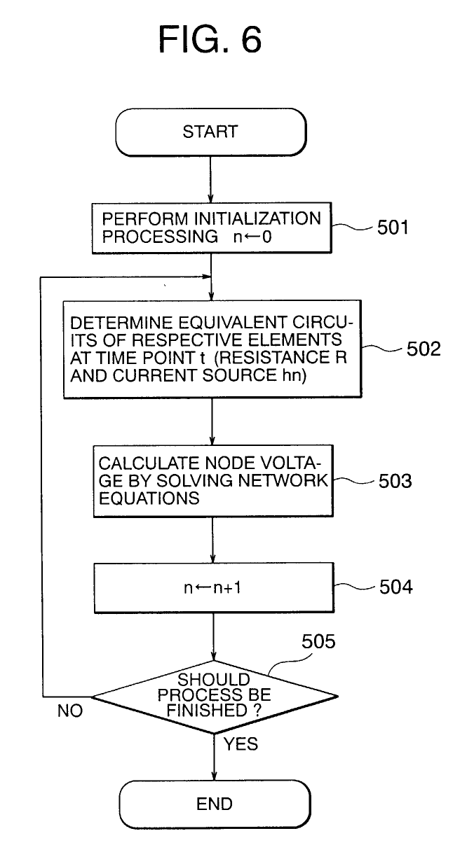

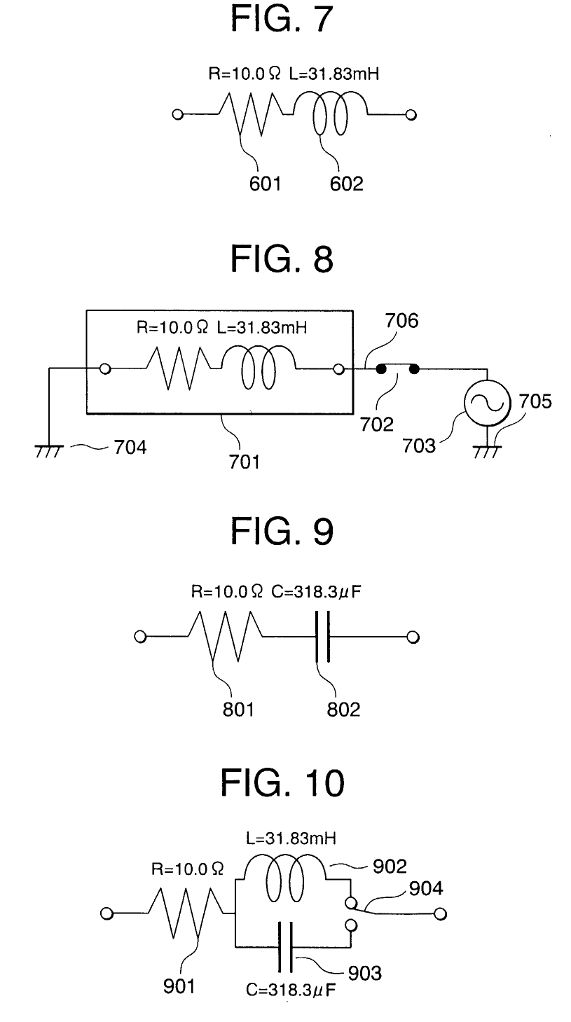

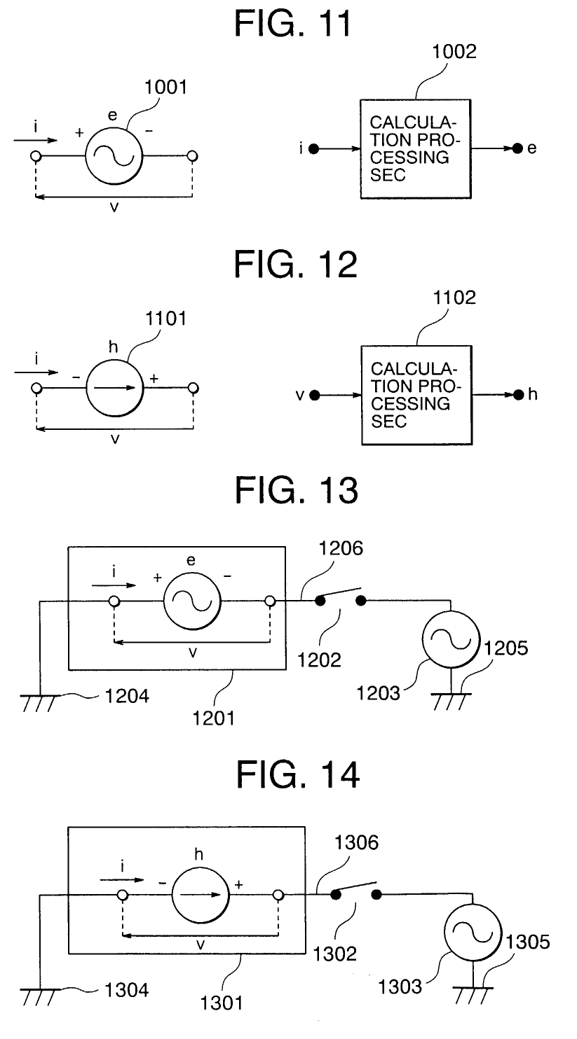

FIG. 6 is a flowchart showing the entire process of an instantaneous value digital simulation (see Reference 2) on each electric circuit that is obtained by converting an electric device into a parallel connection of a resistor and a current source at each time point. At step 501, initialization processing is performed. Character n means that the value concerned in a value at an nth time point t=nΔT. At step 502, equivalent circuits (resistance R and current source hn) of respective elements at the time point t is determined. At step 503, A node voltage is calculated by solving network equations. At step 504, n is incremented by “1.” At step 505, whether to finish the entire process is judged. If the judgment result is negative, the process returns to step 502 to repeat the above steps. If the judgment result is affirmative, the execution of the series of steps is completed. In this process, a device whose characteristic is given as an effective impedance is simulated by expressing it as an equivalent circuit shown in FIG. 3 or 4.

Third and Fourth embodiments described later are physical circuit implementations of the above concept.

Embodiments of the invention will be hereinafter described with reference to the accompanying drawings.

### Embodiment 1

FIG. 1 is an equivalent circuit and a functional block diagram showing a first embodiment of the invention.

In this embodiment, an electric device having an effective value impedance Z (complex number) at a frequency (fundamental frequency) 50 Hz is expressed as the equivalent circuit shown in FIG. 1.

In FIG. 1, reference numeral 101 denotes a resistor; 102, a current source; 103, a current source indication value calculation section; 104, an instantaneous value/effective value conversion section as a first instantaneous value/effective value converting means; 105, an instantaneous value/effective value conversion section as a second instantaneous value/effective value converting means; 106, a calculation processing section as a first calculation processing means; and 107, an effective value/instantaneous value conversion section as a first effective value/instantaneous value converting means.

The resistance value R of the resistor 101 of the equivalent circuit is set at an arbitrary value (excluding 0 and an infinity). A voltage v across the electric circuit and a current i flowing through it are measured. The measured voltage v and current i are converted into effective values V and I by the instantaneous value/effective value conversion sections 105 and 104, respectively. The calculation processing section 106 performs calculation processing on the effective values V and I and thereby determines an effective value output current H of the current source 102. For example, the effective value H is given by

H=(R−Z)(V/Z+I)/2R.

The effective value H is converted into an instantaneous value h by the effective value/instantaneous value conversion section 107. The current source 102 is driven so as to generate the instantaneous value h, whereby the effective value impedance of the circuit shown in FIG. 1 is made equal to Z.

Since the resistor is connected in parallel to the current source in the above-described manner, this embodiment enables an effective value impedance simulation in which even when an external circuit is opened or short-circuited, no infinite current or voltage occurs, no instability occurs in a numerical analysis, and the probability that a physical apparatus is broken is low.

Further, even in the case where an effective value impedance to be simulated varies with time, the only modification needed is to change the calculation formula in the calculation processing section. Therefore, this embodiment enables an effective value impedance simulation in which it is not necessary to prepare a number of physical circuits or initialize an element for connection switching.

### Embodiment 2

FIG. 2 is an equivalent circuit and a functional block diagram showing a second embodiment of the invention.

In this embodiment, an electric device having an effective value impedance Z at a frequency 50 Hz is expressed as the equivalent circuit shown in FIG. 2.

In FIG. 2, reference numeral 201 denotes a resistor; 202, a current source; 203, a voltage source indication value calculation section; 204, an instantaneous value/effective value conversion section as a third instantaneous value/effective value converting means; 205, an instantaneous value/effective value conversion section as a fourth instantaneous value/effective value converting means; 206, a calculation processing section as a second calculation processing means; and 207, an effective value/instantaneous value conversion section as a second effective value/instantaneous value converting means.

The resistance value R of the resistor 201 of the equivalent circuit is set at an arbitrary value (excluding 0 and an infinity). A voltage v across the electric circuit and a current i flowing through it are measured. The measured voltage v and current i are converted into effective values V and I by the instantaneous value/effective value conversion sections 205 and 204, respectively. The calculation processing section 206 performs calculation processing on the effective values V and I and thereby determines an effective value output voltage E of the voltage source 202. For example, the effective value E is given by

E=(R−Z)(V+IZ)/2R.

The effective value E is converted into an instantaneous value e by the effective value/instantaneous value conversion section 207. The voltage source 202 is driven so as to generate the instantaneous value e, whereby the effective value impedance of the circuit shown in FIG. 2 is made equal to Z.

Since the resistor is connected in series to the voltage source in the above-described manner, this embodiment enables an effective value impedance simulation in which even when an external circuit is opened or short-circuited, no infinite current or voltage occurs, no instability occurs in a numerical analysis, and the probability that a physical apparatus is broken is low.

Further, even in the case where an effective value impedance to be simulated varies with time, the only modification needed is to change the calculation formula in the calculation processing section. Therefore, this embodiment enables an effective value impedance simulation in which it is not necessary to prepare a number of physical circuits or initialize an element for connection switching.

### Embodiment 3

FIG. 3 is an equivalent circuit and a flowchart showing a third embodiment of the invention.

In this embodiment, in an instantaneous value digital simulation of an electric circuit transient phenomenon (see Reference 2), an electric device having an effective value impedance Z is expressed as an equivalent circuit that is a parallel connection of a resistor 301 (resistance value R) and a current source 302 (instantaneous value output current hn) shown in FIG. 3 in each time point. In the following description, the suffix n means that the value concerned is a value at an nth time point t=nΔT.

The resistance value of the resistor 301 of the equivalent circuit is set at an arbitrary value (excluding 0 and an infinity). A voltage vn across the electric circuit at a time point t has already been determined by processing of solving the network equations (step 503 in FIG. 6) that was performed at the preceding time point tn−1. A current in flowing through the electric circuit is calculated based on the voltage vn and the values of R and hn (step 303). Effective values Vn and In are calculated by conversion processing (step 304; first converting means) based on the voltage vn and the current in and voltages vn−1, vn−2 and currents in−1, in−2 at the previous time points. An effective value output current Hn+1 of the current source 302 at the next time point tn+1 is calculated by proper calculation processing (step 305; first calculating means) based on the effective values Vn and In. For example, the effective value Hn+1 is given by

Hn+1=(R−Z)(Vn/Z+In)/2R.

The effective value Hn+1 is converted into an instantaneous value hn+1 by effective value/instantaneous value conversion processing (step 306; second converting means). The instantaneous value hn+1 is employed as an instantaneous value output current of the current source 302 at the time point t=(n+1)ΔT and the simulation is continued. In this manner, the effective value impedance of the circuit of FIG. 3 is made equal to Z.

Since the resistor is connected in parallel to the current source in the above-described manner, this embodiment enables an effective value impedance simulation in which even when an external circuit is opened or short-circuited, no infinite current or voltage occurs, no instability occurs in a numerical analysis, and the probability that a physical apparatus is broken is low.

Further, even in the case where an effective value impedance to be simulated varies with time, the only modification needed is to change the calculation formula in the calculation processing section. Therefore, this embodiment enables an effective value impedance simulation in which it is not necessary to prepare a number of physical circuits or initialize an element for connection switching.

### Embodiment 4

FIG. 4 is an equivalent circuit and a flowchart showing a fourth embodiment of the invention.

In this embodiment, in an instantaneous value digital simulation of an electric circuit transient phenomenon (see Reference 2), an electric device having an effective value impedance Z is expressed as an equivalent circuit that is a series connection of a resistor 401 (resistance value R) and a voltage source 402 (instantaneous value output voltage en) shown in FIG. 4 at each time point. In the following description, the suffix n means that the value concerned is a value at an nth time point t=nΔT.

The resistance value of the resistor 401 of the equivalent circuit is set at an arbitrary value (excluding 0 and an infinity). A voltage vn across the electric circuit at a time point t has already been determined by processing of solving the circuit network equations (step 503 in FIG. 6) that was performed at the preceding time point tn−1. A current in flowing through the electric circuit is calculated based on the voltage vn and the values of R and en (step 403). Effective values Vn and In are calculated by conversion processing (step 404; third converting means) based on the voltage vn and the current in and voltages vn−1, vn−2, . . . and currents in−1, in−2, . . . at the previous time points. An effective value output current En+1 of the voltage source 402 at the next time point tn+1 is calculated by proper calculation processing (step 405; second calculating means) based on the effective values Vn and In. For example, the effective value En+1 is given by

En+1=(R−Z)(Vn+InZ)/2R.

The effective value En+1 is converted into an instantaneous value en+1 by effective value/instantaneous value conversion processing (step 406; fourth converting means). The instantaneous value en+1 is employed as an instantaneous value output voltage of the voltage source 402 at the time point t=(n+1)ΔT and the simulation is continued. In this manner, the effective value impedance of the circuit of FIG. 4 is made equal to Z.

Since the resistor is connected in parallel to the voltage source in the above-described manner, this embodiment enables an effective value impedance simulation in which even when an external circuit is opened or short-circuited, no infinite current or voltage occurs, no instability occurs in a numerical analysis, and the probability that a physical apparatus is broken is low.

Further, even in the case where an effective value impedance to be simulated varies with time, the only modification needed is to change the calculation formula in the calculation processing section. Therefore, this embodiment enables an effective value impedance simulation in which it is not necessary to prepare a number of physical circuits or initialize an element for connection switching.

### Embodiment 5

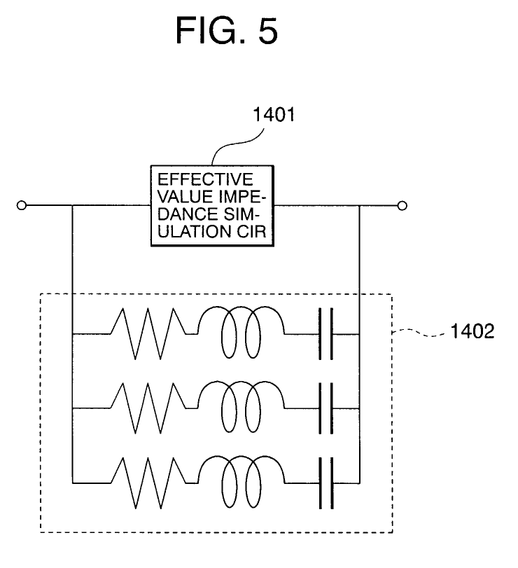

FIG. 5 shows the configuration of a circuit according to a fifth embodiment of the invention.

In FIG. 5, reference numeral 1401 denotes an effective value impedance simulation circuit and reference numeral 1402 denotes a circuit that expresses impedance characteristics in other frequency ranges.

In this embodiment, the circuit 1402 that expresses impedance characteristics in frequency ranges other than a frequency of an effective value impedance as a subject of analysis is provided in addition to the effective value impedance simulation circuit 1401 according to the first or second embodiment.

This makes it possible to construct an impedance simulation circuit that covers a wider frequency range. Naturally, this concept can also be applied to the third and fourth embodiments.

As described above, this embodiment enables circuit simulations in a wide frequency range by adding a circuit for simulation of impedances at frequencies other than a fundamental frequency component.

In the above embodiments, an effective value output current H that should flow through the current source and an effective value voltage E that should be generated by the voltage source are calculated based on both of an effective value current I and voltage V. However, an effective value output current H that should flow through the current source and an effective value voltage E that should be generated by the voltage source may be calculated based on one of an effective value current I and voltage V. The latter case can provide the same advantages as the former case does.

What is claimed is:

1. An effective value impedance simulation method comprising the steps of:
connecting a resistor and an externally controllable current source in parallel and measuring a current that flows through the parallel connection of the resistor and the current source;
converting the measured current into an effective value current;
measuring a voltage that is applied to the parallel connection of the resistor and the current source;
converting the measured voltage into an effective value voltage;
calculating an effective value current that should flow through the current source by using at least one of the effective value current and the effective value voltage; and
converting the calculated effective value current into an instantaneous value current and causing the instantaneous value current to flow through the current source.

2. An effective value impedance simulation method comprising the steps of:
connecting a resistor and an externally controllable voltage source in series and measuring a current that flows through the series connection of the resistor and the voltage source;
converting the measured current into an effective value current;
measuring a voltage that is applied to the series connection of the resistor and the voltage source;
converting the measured voltage into an effective value voltage;
calculating an effective value voltage that should be generated by the voltage source by using at least one of the effective value current and the effective value voltage; and
converting the calculated effective value voltage into an instantaneous value voltage and causing the voltage source to generate the instantaneous value voltage.

3. An effective value impedance simulation method comprising the steps of:
expressing an electric device as a parallel connection of a resistor and a current source at a time point concerned, and calculating an effective value current and an effective value voltage at the time point concerned based on a current and currents that flows and flew through the parallel connection at the time point concerned and preceding time points and a voltage and voltages that develops and developed across the parallel connection at the time point concerned and the previous time points;
calculating an effective value current that will flow through the current source based on one of the effective value current and the effective value voltage; and
converting the calculated effective value current into an instantaneous value current and employing the instantaneous value current as an output current of the current source at the next time point.

4. An effective value impedance simulation method comprising the steps of:
expressing an electric device as a series connection of a resistor and a voltage source at a time point concerned, and calculating an effective value current and an effective value voltage at the time point concerned based on a current and currents that flows and flew through the series connection at the time point concerned and preceding time points and a voltage and voltages that develops and developed across the series connection at the time point concerned and the previous time points;
calculating an effective value voltage that will develop across the voltage source at the next time point based on at least one of the effective value current and the effective value voltage; and
converting the calculated effective value voltage into an instantaneous value voltage and employing the instantaneous value voltage as an output voltage of the voltage source at the next time point.

5. The effective value impedance simulation method according to claim 1, further comprising the step of simulating an effective value impedance at a frequency component other than an effective value impedance at a fundamental frequency component as a subject of analysis of the above steps.

6. The effective value impedance simulation method according to claim 2, further comprising the step of simulating an effective value impedance at a frequency component other than an effective value impedance at a fundamental frequency component as a subject of analysis of the above steps.

7. The effective value impedance simulation method according to claim 3, further comprising the step of simulating an effective value impedance at a frequency component other than an effective value impedance at a fundamental frequency component as a subject of analysis of the above steps.

8. The effective value impedance simulation method according to claim 4, further comprising the step of simulating an effective value impedance at a frequency component other than an effective value impedance at a fundamental frequency component as a subject of analysis of the above steps.

9. An effective value impedance simulation apparatus comprising:
first instantaneous value/effective value converting means for connecting a resistor and an externally controllable current source in parallel, measuring an instantaneous value current that flows through the parallel connection of the resistor and the current source, and converting the measured instantaneous value current into an effective value current;
second instantaneous value/effective value converting means for measuring an instantaneous value voltage that is applied to the parallel connection of the resistor and the current source, and converting the measured instantaneous value voltage into an effective value voltage;
first calculation processing means for calculating an effective value current that should flow through the current source by using at least one of the effective value current and the effective value voltage; and
first effective value/instantaneous value converting means for converting the calculated effective value current into an instantaneous value current and causing the instantaneous value current to flow through the current source.

10. An effective value impedance simulation apparatus comprising:
third instantaneous value/effective value converting means for connecting a resistor and an externally controllable voltage source in series, measuring an instantaneous value current that flows through the series connection of the resistor and the current source, and converting the measured instantaneous value current into an effective value current;
fourth instantaneous value/effective value converting means for measuring an instantaneous value voltage that is applied to the series connection of the resistor and the current source, and converting the measured instantaneous value voltage into an effective value voltage;
second calculation processing means for calculating an effective value voltage that should be generated by the voltage source by using at least one of the effective value current and the effective value voltage; and
second effective value/instantaneous value converting means for converting the calculated effective value voltage into an instantaneous value voltage and causing the voltage source to generate the instantaneous value voltage.

11. The effective value impedance simulation apparatus according to claim 9, further comprising a circuit for simulating an effective value impedance at a frequency component other than an effective value impedance at a fundamental frequency component as a subject of analysis of the above means.

12. The effective value impedance simulation apparatus according to claim 10, further comprising a circuit for simulating an effective value impedance at a frequency component other than an effective value impedance at a fundamental frequency component as a subject of analysis of the above means.

13. An effective value impedance simulation program for causing a computer to execute:
a first converting step of expressing an electric device as a parallel connection of a resistor and a current source at a time point concerned, and calculating an effective value current and an effective value voltage at the time point concerned based on a current and currents that flows and flew through the parallel connection at the time point concerned and preceding time points and a voltage and voltages that develops and developed across the parallel connection at the time point concerned and the previous time points;
a first calculating step of calculating an effective value current that will flow through the current source at the next time point based on at least one of the effective value current and the effective value voltage; and
a second converting step of converting the calculated effective value current into an instantaneous value current and employing the instantaneous value current as an output current of the current source at the next time point.

14. An effective value impedance simulation program for causing a computer to execute:
a third converting step of expressing an electric device as a series connection of a resistor and a voltage source at a time point concerned, and calculating an effective value current and an effective value voltage at the time point concerned based on a current and currents that flows and flew through the series connection at the time point concerned and preceding time points and a voltage and voltages that develops and developed across the series connection at the time point concerned and the previous time points;
a second calculating step of calculating an effective value voltage that will develop across the voltage source at the next time point based on at least one of the effective value current and the effective value voltage; and
a fourth converting step of converting the calculated effective value voltage into an instantaneous value voltage and employing the instantaneous value voltage as an output voltage of the voltage source at the next time point.
